(19) United States
(12) Patent Application Publication
(10) Pub. No.: US 2018/0032620 A1
(43) Pub. Date: Feb. 1, 2018

(54) SEARCH QUERY MODIFICATION USING PERSONALIZED PROFILE

(71) Applicant: ENT. SERVICES DEVELOPMENT CORPORATION LP, Houston, TX (US)

(72) Inventors: Kas KASRAVI, West Bloomfield, MI (US); Kieran MCCORRY, Belfast (GB); Simon THOMASON, Ashford, NJ (US); Marie RISOV, Bloomfield Hills, MI (US); Mark DONNELLY, Galway (IE)

(73) Assignee: ENT. SERVICES DEVELOPMENT CORPORATION LP, Houston, TX (US)

(21) Appl. No.: 15/552,458

(22) PCT Filed: Feb. 20, 2015
(86) PCT No.: PCT/US2015/016826

§ 371 Date: Aug. 21, 2017

(51) Int. Cl. G06F 17/30

(52) U.S. Cl. CPC G06F 17/30867; G06F 17/30699

(57) ABSTRACT

In example implementations, a personalized profile of a user is generated from at least a contextual information source regarding the user other than prior search queries from the user. An information store is searched using a search query that is modified based on the personalized profile of the user that has been generated.

### BACKGROUND

With the advent of computing systems, large amounts of information are stored. To retrieve and view such information, however, a user first has to locate it. For example, users can employ one of a wide variety of different search engines to locate desired information available on information stores. Specifically, a user may provide a search query to a search engine, and the search engine then returns the relevant information.

### BRIEF DESCRIPTION OF THE DRAWINGS

FIG. 1 is a flowchart of an example method for generating a personalized profile of a user that is used to modify search queries made by the user.

FIGS. 2 and 3 are flowcharts of example methods for dynamically modifying or updating a personalized profile of a user that is used to modify search queries made by the user.

FIG. 4 is a flowchart of an example method for performing a search using a personalized profile of a user to acquire more relevant search results, by modifying a search query using contextual keywords of the user's personalized profile.

FIGS. 5 and 6 are flowcharts of example methods for selecting which keywords of the user's personalized profile on which basis to modify a search query by leveraging different personas of the user in his or her personalized profile.

FIGS. 7, 8, and 9 are diagrams of example systems in which search query modification using personalized profiles can be achieved.

FIG. 10 is a flowchart of another example method for generating a personalized profile of a user.

FIG. 11 is a flowchart of another example method for performing a search using a personalized profile of a user.

FIG. 12 is a diagram of another example system in which search query modification using personalized profiles can be achieved.

### DETAILED DESCRIPTION

As noted in the background, users commonly provide search queries to search engines, which in response return relevant search results. Many search queries, however, are vague, and can provide search results that do not identify the desired information that a user is seeking. For example, for a given search query like “unionized,” a user who is an employment lawyer will likely be searching for much different information than a different user who is a chemist. The search engine, though, does not know this, and may provide chemistry-related search results that are irrelevant to the employment lawyer, and employment law-related search results that are irrelevant to the chemist.

Existing techniques attempt to provide more meaningful search results in a reactive manner, by considering past searches a particular user may have already performed. For example, an employment lawyer may have previously input search queries like “trade unions,” whereas a chemist may have previously input search queries such as “ionized.” From the users' past searches, then, existing techniques may be able to tailor search results that are more likely relevant to the information that the users are seeking.

However, such techniques are unhelpful if the users have not performed any related prior searches. For example, if the employment lawyer has not entered prior search queries relevant to unions, then the search engine may not be able to determine that the search query “unionized” should be evaluated in the context of trade unions. Similarly, if the chemist has not entered prior search queries relevant to ions, then the search engine may not be able to determine that the search query “unionized” should be evaluated in this context. This problem is further exacerbated if the user's search patterns change over time in response to changing interests or professional assignments.

Disclosed herein are techniques for modifying search queries to provide more relevant results in a proactive manner, using personalized profiles. A personalized profile of a user is generated at least from contextual information sources regarding the user other than prior search queries. These contextual information sources can include social media web sites, online corporate directories, and so on. When the user inputs a search query, the query is modified based on the user's personalized profile before the search is performed. The search results returned to the user are likely to be more relevant to the information that the user is seeking.

For example, users may have accounts with a professional-oriented social media web site identifying their professions, education, current and prior places of employment, professional interests, and so on. From this contextual information source, the techniques disclosed herein can build a personalized profile for an employment lawyer that is different than a personalized profile constructed for a chemist. Therefore, when each user enters the search query “unionized,” the search query is modified in a different way, to provide employment law-related search results for the employment lawyer, and chemistry-related search results for the chemist.

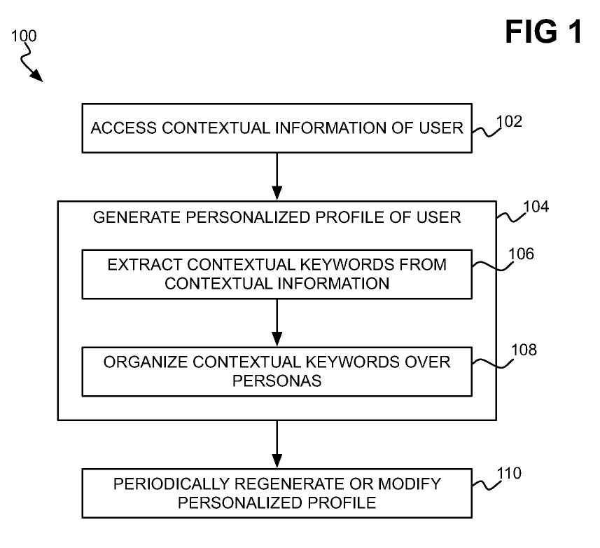

FIG. 1 shows an example method 100 for generating a personalized profile of a user. The method 100 is performed by a processor of a computing device. The method 100 may therefore be implemented as computer-executable code of a computer program that the processor executes to perform the method 100.

The method 100 includes accessing contextual information of the user (102). Contextual information of the user is information regarding the user that provides background information of the user, so that search queries later made by the user can be more fully assessed. Contextual information of the user thus provides meaning to search queries, insofar as it provides information regarding the user that made the queries.

Contextual information of the user is accessed from one or more contextual information sources. While the contextual information sources can include prior search queries that the user made, the contextual information sources include at least one other type of contextual information source. Examples include social media web sites, including professionally oriented such web sites. A user typically lists personal and professional information on such web sites, such as the user's interests, hobbies, work history, education, and so on.

In the case of contextual information sources that are social media web sites, a user may provide access information to each web site, such as username and password information. This access information permits the method 100 to access the social media web sites with the user's permission. Social media web sites generally have well defined application programming interfaces (APIs) by which the content (i.e., contextual information) stored thereat is programmatically accessible.

From this contextual information of the user, the method 100 generates a personalized profile of the user (104). The personalized profile is a set of contextual keywords used to modify search queries made by the user so that the search results obtained are more relevant to the user. As such, generation of the personalized profile of the user includes extracting contextual keywords from the contextual information that has been accessed from the contextual information sources (106).

In general, contextual keyword extraction is performed using natural language processing (NLP) techniques. NLP techniques permit computing devices to derive meaning from the human-entered natural language input of the contextual information of the contextual information sources. NLP techniques can employ machine learning, such as statistical machine learning, techniques. Other examples of available NLP techniques include co-reference resolution, morphological segmentation, named entity recognition, part-of-speech tagging, parsing, semantic analysis, and word sense disambiguation.

The contextual keywords that are extracted as the personalized profile of the user can be of differing types. Domain keywords can include the domains of the type of information in which the user is likely interested. For example, an employment lawyer may have contextual information that results in the extraction of domain keywords such as “employment law,” whereas a chemist may have contextual information that results in the extraction of domain keywords such as “chemistry.” Other types of contextual keywords that may be extracted include language keywords specifying the languages understood by the user, such as English, Japanese, French, and so on, as well as reading level keywords specifying the reading level of the user, such as high school reading level, college reading level, and so on. Still other types of contextual keywords include location keywords specifying the locations where the user has been, went to school, currently lives and lived in the past, and so on.

The extraction of the contextual keywords from the contextual information can in one implementation include referencing other types of information sources to provide even further contextual keywords. For example, if the contextual domain keywords “materials engineering” are extracted, external information sources can be referenced that provide additional relevant contextual keywords, such as “metals,” “plastics,” “composites,” and so on, which can become part of the personalized profile. Examples of such information sources include online encyclopedias, industry-specific glossaries, reference materials for particular subject matter, and so on.

In one implementation, the method 100 may organize the contextual keywords over different personas of the user (108). The personas of a user can correspond to the user's different life roles, and can correspond to different types of contextual information regarding the user. As one example, the user may have a professional persona and a personal persona. Contextual keywords related to the user's job, for instance, may be organized as part of his or her professional persona, whereas contextual keywords related to the user's interests and hobbies may be organized as part of his or her personal persona. The personas as a whole make up the user's personalized profile.

Thus, a physicist who enjoys surfing may have the contextual domain keyword “physics” in his or her professional persona, and the contextual domain keyword “surfing” in his or her personal persona. As described later in the detailed description, depending on when and/or where the user is performing a search, the appropriate persona is then accessed. For example, if the physicist were to enter the search query “optimal waves,” the search results will markedly differ for this phrase in the context of physics as compared to as in the context of surfing.

The personalized profile that is generated using the method 100 is dynamic. This means that the personalized profile can change over time, as, for instance, the contextual information of the user changes. As such, the personalized profile is periodically regenerated or modified (110). In a basic implementation, for instance, parts 102 and 104 of the method 100 may be periodically re-performed to generate a new personalized profile of the user that replaces the user's existing personalized profile. In more complex implementations, the existing personalized profile is modified and not simply replaced.

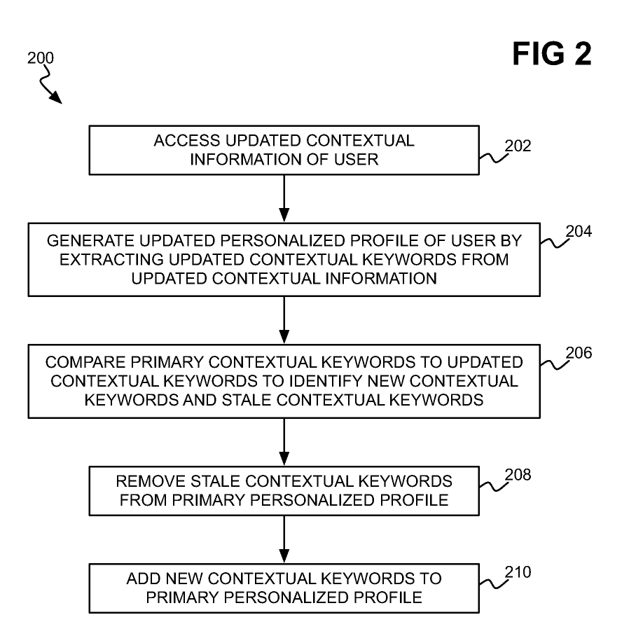

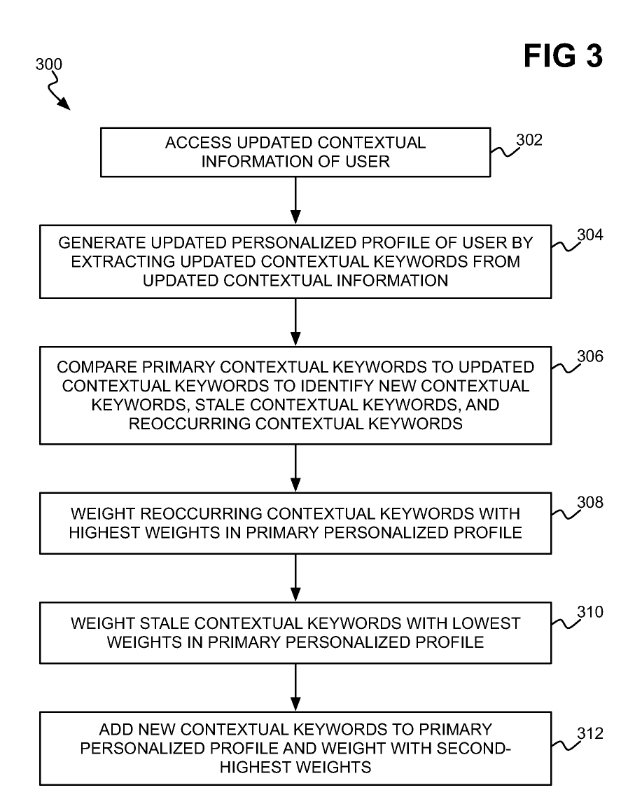

FIGS. 2 and 3 show example methods 200 and 300, respectively, for modifying a previously generated personalized profile in part 110 of the method 100. In the methods 200 and 300, the already generated personalized profile of a user is referred to as the primary personalized profile of the user, and the new personalized profile of the user that is generated and compared to the primary personalized profile is referred to as the updated personalized profile of the user. Both the methods 200 and 300 compare the updated personalized profile to the primary personalized profile, and then make changes to the primary personalized profile so that it remains temporally accurate.

In the method 200, updated contextual information of the user is accessed from the same or different contextual information sources that were used in part 102 of the method 100 (202). The updated personalized profile is generated by extracting updated contextual keywords from the updated contextual information (204), in the same manner as has been described in relation to part 106 of the method 100. These updated contextual keywords may be organized over personas as well.

The method 200 compares the (primary) contextual keywords of the primary personalized profile of the user to the updated contextual keywords of the updated personalized profile of the user (206). This comparison identifies two relevant types of keywords in the method 200: new contextual keywords and stale contextual keywords. New contextual keywords are keywords present in the updated personalized profile that are absent from the primary personalized profile. Stale contextual keywords are keywords present in the primary personalized profile that are absent from the updated personalized profile.

The method 200 removes the stale contextual keywords from the primary personalized profile (208), and similarly adds the new contextual keywords to the primary personalized profile (210). In this way, the primary personalized profile remains up-to-date. The updated personalized profile is used in the method 200 as a way to maintain the accuracy of the primary personalized profile, without necessarily replacing the primary personalized profile.

In the method 300, updated contextual information of the user is again accessed from the same or different contextual information sources as in the method 200 (302), and the updated personalized profile is likewise again generated by extracting upgraded contextual keywords from the updated contextual information (304). The primary contextual keywords are also again compared to the updated contextual keywords (306), but in addition to identifying stale contextual keywords and new contextual keywords, the method 300 identifies reoccurring contextual keywords. Reoccurring contextual keywords are keywords present in both the primary personalized profile and the updated personalized profile of the user.

The method 300 weights reoccurring contextual keywords within the primary personalized profile with highest weights (308), and weights stale contextual keywords within the primary personalized profile with lowest weights (310). The method 300 adds new contextual keywords to the primary personalized profile, and weights them with second-highest (or second-lowest) weights (312). As such, contextual keywords that were present in the past and are still present have the highest weights, keywords that are newly present have middle weights, and keywords that are no longer present have lowest weights.

Other weighting approaches can also be employed, particularly as the primary personalized database is modified a number of successive times. Weighting contextual keywords can ensure that search results are returned that correspond to the user's current and past interests. That is, the weights correspond to the current contextual relevance of the keywords to the user. For example, a user may originally list his or her interests on a social media web site as hiking and surfing. Later, the user may update the interests to hiking and snowboarding. The user may thus still be interested in surfing, but it is not as primary an interest as hiking and snowboarding are. In response to a search query for “best places to vacation,” results for places in which there is good hiking and snowboarding are likely to be more relevant to the user than places in which there is good hiking and surfing.

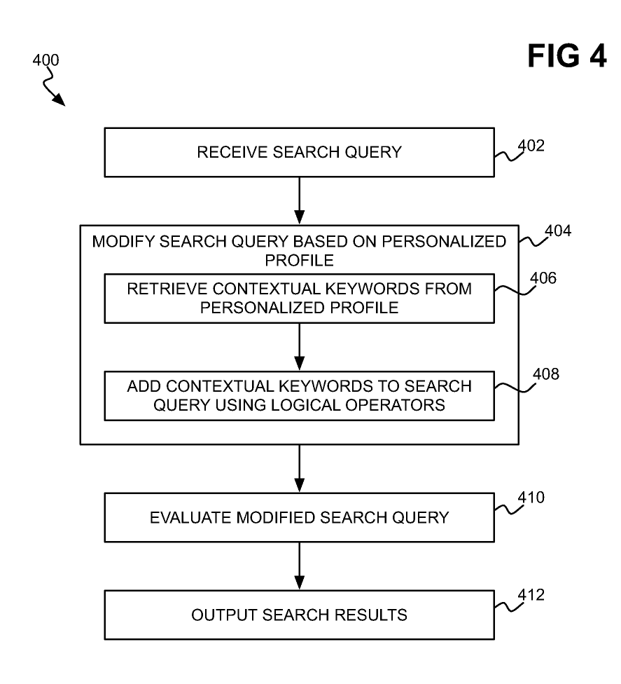

FIG. 4 shows an example method 400 for performing a search using a personalized profile of a user. As with the method 100, the method 400 is performed by a processor of a computing device. The method 400 may thus be implemented as computer-executable code that the processor executes to perform the method 400.

The method 400 receives a search query from a user (402). For example, in relation to an Internet search engine available on an Internet web site, the user may input the search query. The purpose of the search query from the perspective of the user is to retrieve relevant search results from an information store. In the context of an Internet search engine, the search results may be a list of web pages that are likely to include information relevant to the search query.

The method 400 modifies the search query based on the user's (primary) personalized profile. Such modification can include the following. Contextual keywords are retrieved from the user's personalized profile (406). The contextual keywords are then added or appended to the search query using logical operators (408).

As an example, consider the search query “unionized” for two different users, an employment lawyer and a chemist. The contextual keyword of the lawyer's personalized profile may be “law,” whereas the contextual keyword of the chemist's personalized profile may be “chemistry.” The contextual keyword is added or appended to the search query using a logical AND operator, so that the modified search query is “unionized AND law” for the lawyer and is “unionized AND chemistry” for the chemist. The search query is thus refined so that it is likely to result in more relevant search results for each user.

For multiple contextual keywords, the search query can be modified by adding or appending the contextual keywords to the query using a logical AND operator and separating each keyword within the modified query using a logical OR operator. Thus, for the search query QUERY and the contextual keywords KEYWORD1 and KEYWORD2, the resulting modified search query is “QUERY AND (KEYWORD1 OR KEYWORD2).” In this modified search query, the terms “AND” and “OR” are the logical operators AND and OR, respectively.

As has been described, the contextual keywords may have associated weights. Where evaluation of search queries using weights is supported, such as by an Internet search engine that supports weighted query terms, each keyword may further be multiplied or modified by its associated weight. For example, a contextual keyword KEYWORD1 may have a weight of 90% on a scale from 0-100%, whereas a contextual keyword KEYWORD2 may have a weight of 30%. For the search query QUERY and these keywords, the resulting modified search query may “QUERY AND (90%×KEYWORD1 OR 30%×KEYWORD2),” or “QUERY AND (KEYWORD WITH 90% WEIGHT OR KEYWORD2 WITH 30% WEIGHT),” depending on how weights are specified for evaluation.

The method 400 evaluates the resulting modified search query against an information store to retrieve search results relevant to the modified search query (410). Stated another way, the method 400 evaluates the resulting modified search query against the information store to retrieve search results relevant to the search query for the user in question. The information store is a database storing information items that are searched, where items matching the modified search query are the search results. In the context of an Internet search engine, the information items may be web page summaries and web page links. In this example, the method 400 may send the modified search query to the Internet search engine and responsively receive the search results, or the method 400 can be implemented as part of the search engine itself. The search results are then output to the user for review (412), such as by being displayed to the user on the same or different computing device as that which is performing the method 400.

As has been described, the contextual keywords of the user's personalized profile are retrieved and added or appended to the user's search query to generate a modified search query that will likely provide search results that are more relevant to the user. In the simplest form, all the contextual keywords may be retrieved from the user's personalized profile and added or appended to the search query. However, a personalized profile may include a large number of contextual keywords, such as hundreds or more, and in some implementations it may be appropriate to select the best contextual keywords for adding to the search query.

Relevant contextual keywords may be selected in a number of different ways. For example, an external information source, such as those that have been described above in relation to part 106, may be employed to better categorize the search query. A search query of “unionized,” for instance, may be categorized as being related to a scientific and/or professional field such as physics and law. Therefore, if either of these two contextual keywords is present in the user's personalized profile, it is selected as a contextual keyword to add to the search query.

This approach thus references an external information source in the opposite way in which it is employed in part 106. In part 106, an external information source is referenced to add additional relevant contextual keywords, such as “metals,” “plastics,” and “composites” as being related to “materials engineering.” By comparison, in part 412, the external information source is referenced to determine which contextual keywords of the user's profile to add to the search query. Thus, if the search query is “metals,” then “materials engineering” may be added to the search query if present in the user's personalized profile.

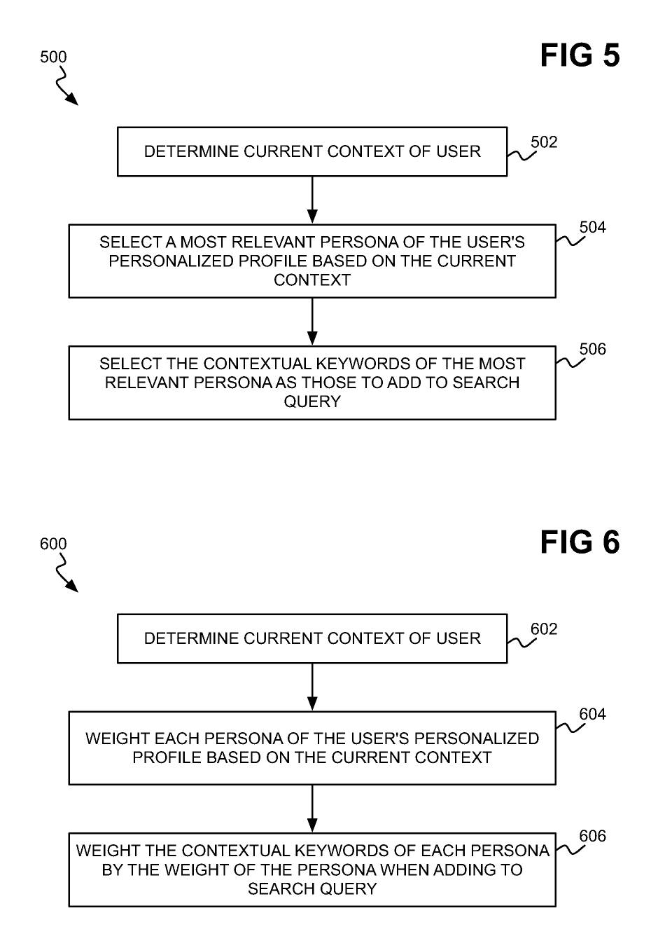

FIGS. 5 and 6 show example methods 500 and 600, respectively for selecting relevant contextual keywords of a user's personalized profile when the keywords are organized over personas. The methods 500 and 600 are thus other ways by which selected contextual keywords of a personalized profile are selected to add to a search query. The methods 500 and 600 may each be performed between parts 406 and 408 of the method 400, for instance.

In the method 500, the user's current context is determined (502). The current context of the user includes the circumstances surrounding the user's present situation. For instance, the current context can include or be based on the current time and/or day, the user's current location, the computing device that the user is currently using to perform a search, and so on.

The most relevant of the user's personas within the personalized profile of the user is selected based on the user's current context (504). This is achieved by matching the current context to the personas to identify the current persona in the context of which the user is performing a search. For example, the user may have a work persona and a personal persona. If the current context is 2 PM on a workday, the user's current location is his or her workplace, and the user is currently using his or her work computer, then the work persona is most likely the user's current persona. By comparison, if the current context is 8 PM on a Friday, the user's current location is his or her home, and the user is currently using his or her home computer, then the personal persona is most likely the user's current persona.

The method 500 selects the contextual keywords within the user's personalized profile that are organized under the most relevant (i.e., current) persona as those to add to the search query that has been entered by the user (506). The contextual keywords organized under other personas, by comparison, are not added. It can thus be stated that the search query is modified based on just the current persona of the user, which is the most relevant persona for the user's current context.

In the method 600, the user's current context is again determined (602), as in part 502 of the method 500. However, rather than selecting the most relevant persona of the user as in the method 500, the method 600 weights each persona of the user's personalized profile based on the current context (604). For example, the user may have a work persona and a personal persona, as before. If the current context is 7 PM, the user's current location is his or her home, and the user is currently using his or her work computer, it may be unclear as to whether the user is in a work persona or a personal persona.

The fact that it is 7 PM—outside of normal business hours—suggests a personal persona, as does the fact that the user's current location is at home. However, the fact that the user is using his or her work computer suggests that the user may be working from home in the evening, and thus suggests a work persona. If each of these criteria (current time, current location, and current computing device) is weighted equally, then the work persona has a weight of one (or one third) since it satisfies one criterion. By comparison, the personal persona has a weight of two (or two thirds) since it satisfies the other two criteria.

The contextual keywords of each persona are thus weighted by the persona's weight when adding the keywords to the search query (606). It is noted that such weighting is different than and can be in addition to the weights that have been described above in relation to the method 300 and to part 408 of the method 400, which are weights on a contextual keyword basis, not on a persona basis as in the method 600. The method 600 is a way in which the search query is modified based on the user's personas, as weighted by the user's current context.

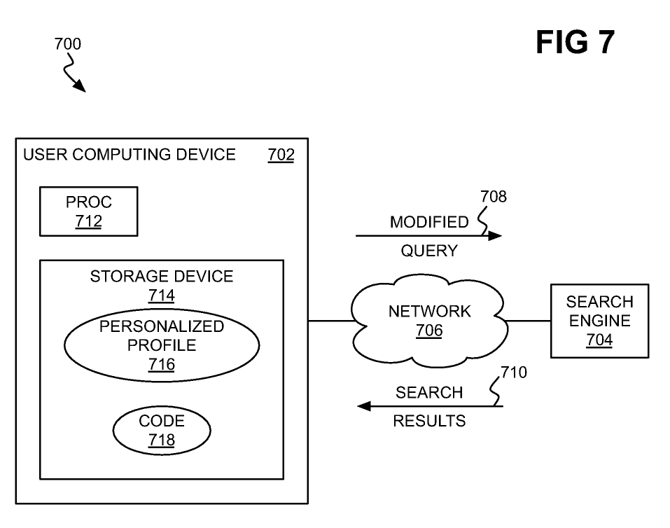

FIGS. 7, 8, and 9 show example systems 700, 800, and 900, respectively of how the techniques disclosed herein for modifying a search query based on a user's personal profile can be implemented in practice. In FIG. 7, a user computing device 702 is communicatively coupled to a search engine 704 over a network 706, such as the Internet and/or another type of network. A user enters a search query at his or her computing device 702, which generates a modified search query and sends the modified search query to the search engine 704 per the arrow 708. The search engine 704, which may be a server computing device, returns search results for the modified search query back to the computing device 702 per the arrow 710.

The user computing device 702 of FIG. 7 may be a desktop or laptop computer, or another type of computing device. The computing device 702 includes at least a processor 712 and a storage device 714, and may and typically does include other components as well. The storage device 714 may include volatile and non-volatile storage media on which the user's personalized profile 716 and computer-executable code 718 are stored. In the example of FIG. 7, then, the processor 712 executes the code 718 to generate the personalized profile 716 and perform a search of the information store maintained by the search engine 704 using a modified query that the processor 712 itself generates. That is, the user computing device 702 can perform the methods that have been described.

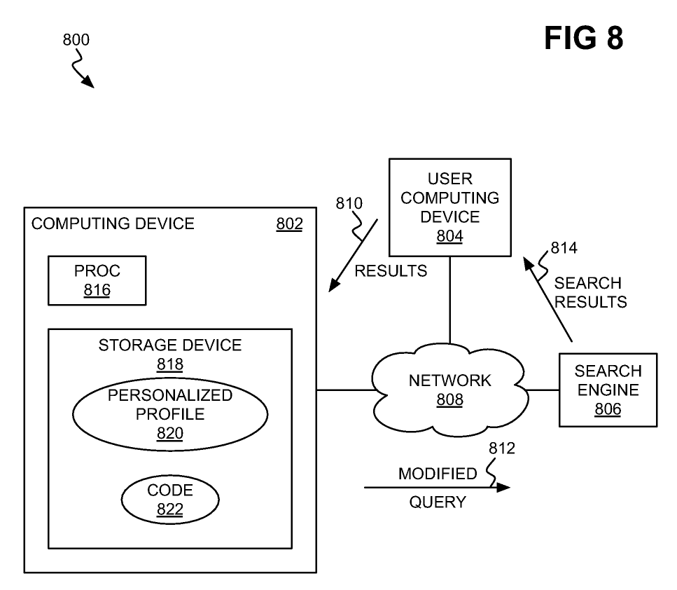

In FIG. 8, a computing device 802, a user computing device 804, and a search engine 806 are communicatively coupled to one another over a network 808, such as the Internet and/or another type of network. A user enters a search query at his or her computing device 804, which sends the query to the computing device 802 per the arrow 810. The computing device 804 modifies the search query based on the user's personalized profile, and sends the modified query to the search engine 806, per the arrow 812. The search engine 806 returns search results for the modified search query back to the user computing device 804 per the arrow 814.

The computing device 802 of FIG. 8 may be a server computing device maintained by a custom search provider to offer as a service to users like the user of the user computing device 804. The computing device 802 includes at least a processor 816 and a storage device 818, and may and typically does include other components as well. The storage device 818 may include volatile and non-volatile storage media on which the user's personalized profile 820 (as well as those of users other than the user of the user computing device 804) and computer-executable code 822 are stored. In the example of FIG. 8, then, the processor 816 executes the code 822 to generate the personalized profile 820 and to generate a modified query from the query that the user entered at the user computing device 804. That is, the computing device 802, not the user computing device 804, can perform the methods that have been described.

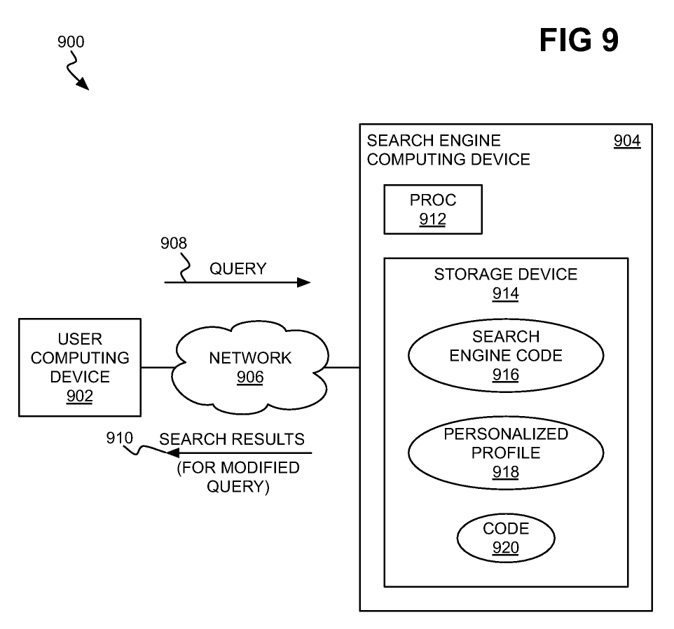

In FIG. 9, a user computing device 902 is communicatively coupled to a search engine computing device 904 over a network 906, such as the Internet and/or another type of network. A user enters a search query at his or her computing device 902, which sends the query to the search engine computing device 904 per the arrow 908. The computing device 904 modifies the search query based on the user's personalized profile and returns search results for the modified query back to the user computing device 902 per the arrow 910.

The search engine computing device 904 of FIG. 9 may be a server computing device maintained by a search service. The computing device 904 includes at least a processor 912 and a storage device 914, and may and typically does include other components as well. The storage device 914 may include volatile and non-volatile storage media on which search engine computer-executable code 916, the user's personalized profile 918 (as well as those of users other than the user of the user computing device 902) and computer-executable code 920 are stored. The processor 912 executes the search engine code 916 to perform a search of a search query. The processor 912 executes the code 920 to generate the personalized profile 918 and to generate a modified query from the query that the user entered at the user computing device 902. That is, the search engine computing device 904, not the user computing device 902, can perform the methods that have been described.

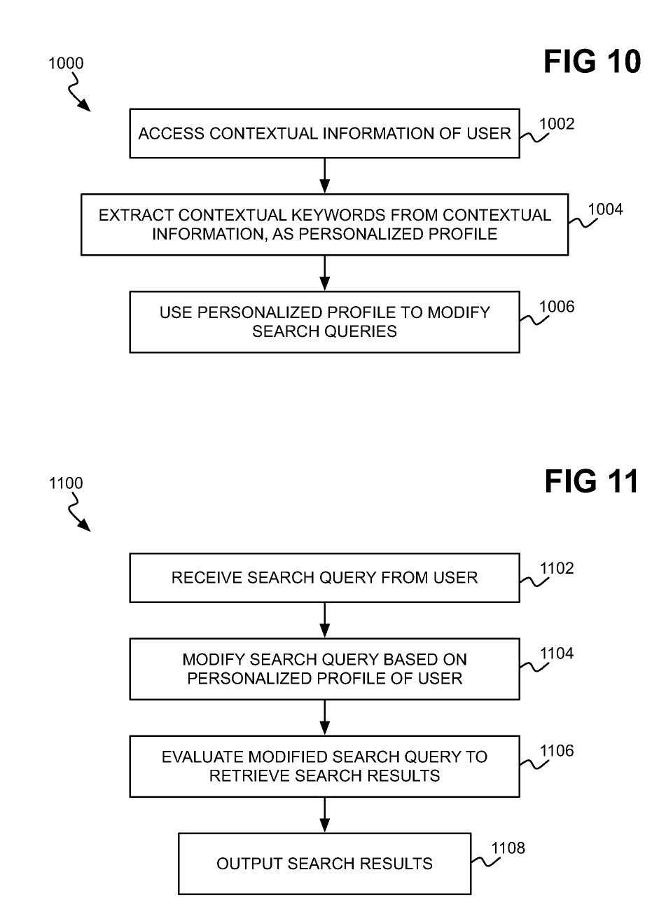

FIG. 10 shows another example method 1000 that is a generalization of the method 100 that has been described above. Like the other methods that have been described, the method 1000 can be implemented as code stored on a non-transitory computer-readable medium. Execution of the code by a processor causes the method 1000 to be performed.

The method 1000 includes accessing contextual information of a user from at least a contextual information source other than prior search queries made by the user (1002). The method 1000 includes extracting the contextual keywords from the contextual information of the user, as a personalized profile of the user (1004). The method 1000 includes using the personalized profile of the user to modify search queries made by the user when searching an information store to retrieve search results relevant to the user (1006).

FIG. 1100 shows another example method 1100 that is a generalization of the method 400 that has been described above. Like the other methods that have been described, the method 1100 can be implemented as code stored on a non-transitory computer-readable medium. Execution of the code by a processor causes the method 1100 to be performed.

The method 1100 includes receiving a search query from a user (1102). The method 1100 includes modifying the search query based on a personalized profile of the user that has been generated from at least a contextual information source regarding the user other than prior search queries received from the user (1104). The method 1100 includes evaluating the modified search query against an information store to retrieve search results relevant to the modified search query (1106). The method 1100 includes outputting the search results to the user (1108).

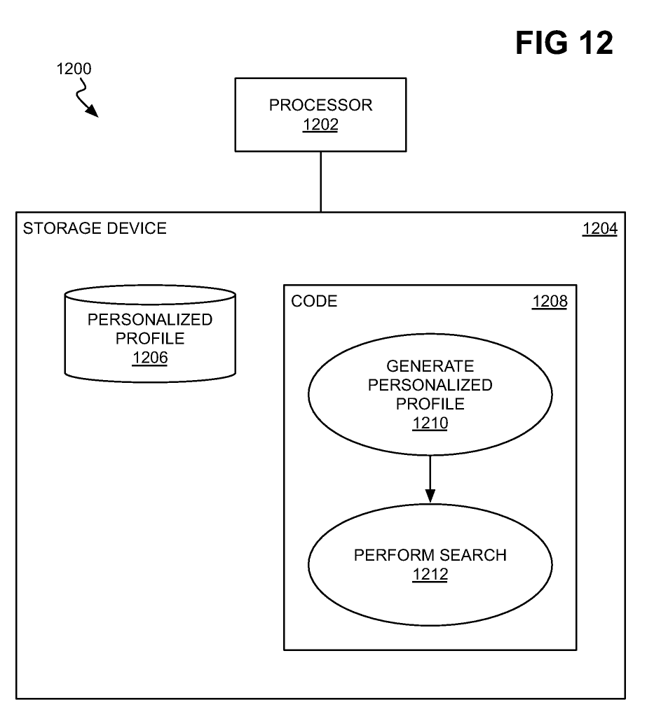

FIG. 12 shows another example system 1200 that can be used to perform the methods that have been described, such as the methods 1000 and 1100. The system 1200 includes a processor 1202 and a storage device 1204. The storage device 1204 stores a personalized profile 1206 of a user, and computer-executable code 1208.

The processor 1202 executes the computer-executable code 1208 to perform at least the following. The processor 1202 executes the code 1208 to generate the personalized profile 1206 from at least a contextual information source regarding the user other than prior search queries made by the user (1210). The processor 1202 executes the code 1208 to perform a search of an information store using a search query modified based on the personalized profile 1206 (1212).

We claim:

1. A non-transitory computer-readable medium storing code that when executed by a processor causes the processor to:
receive a search query from a user;
modify the search query based on a personalized profile of the user generated from at least a contextual information source regarding the user other than prior search queries received from the user;
evaluate the modified search query against an information store to retrieve search results relevant to the modified search query; and
output the search results to the user.

2. The non-transitory computer-readable medium of claim 1, wherein the processor is to modify the search query by:
determining a current context of the user based on at least one of a current time, a current day, and a current location of the user;
selecting a current persona of the user from a plurality of personas of the user within the personalized profile of the user, using the current context of the user, each person corresponding to different types of contextual information regarding the user; and
modifying the search query based on just the current persona of the user.

3. The non-transitory computer-readable medium of claim 1, wherein the processor is to modify the search query by:
determining a current context of the user based on at least one of a current time, a current day, and a current location of the user;
weighting each persona of a plurality of personas of the user within the personalized profile of the user, based on the current context of the user, each persona corresponding to different types of contextual information regarding the user; and
modifying the search query based on the weighted personas of the user.

4. The non-transitory computer-readable medium of claim 1, wherein the processor is to modify the search query by:
retrieving a contextual keyword from the personalized profile of the user; and
adding the contextual keyword to the search query using a logical AND operator.

5. The non-transitory computer-readable medium of claim 1, wherein the processor is to modify the search query by:
retrieving a plurality of contextual keywords from the personalized profile of the user; and
adding the plurality of contextual keywords to the search query using a logical AND operator, the contextual keywords separated from one another within the search query by one or more logical OR operators.

6. The non-transitory computer-readable medium of claim 5, wherein each contextual keyword has a weight corresponding to its contextual relevance to the user.

7. A method comprising:
accessing, by a processor, contextual information of a user from at least a contextual information source other than prior search queries made by the user;
extracting, by the processor, contextual keywords from the contextual information of the user, as a personalized profile of the user; and
using, by the processor, the personalized profile of the user to modify search queries made by the user when searching an information store to retrieve search results relevant to the user.

8. The method of claim 7, further comprising:
organizing the contextual keywords over a plurality of personas of the user within the personalized profile, each persona corresponding to different types of the contextual information of the user.

9. The method of claim 7, further comprising:
periodically regenerating, by the processor, the personalized profile of the user by accessing updated contextual information of the user from at least the contextual information source and again extracting the contextual keywords from the contextual information.

10. The method of claim 7, wherein the personalized profile of the user is a primary personalized profile of the user, the method further comprising:
accessing, by the processor, updated contextual information of the user from at least the contextual information source;
extracting, by the processor, updated contextual keywords from the updated contextual information, as an updated personalized profile of the user; and
modifying the primary personalized profile of the user based on the updated personalized profile of the user.

11. The method of claim 10, wherein modifying the primary personalized profile of the user based on the updated personalized profile of the user comprises:
comparing the contextual keywords of the primary personalized profile to the updated contextual keywords of the updated personalized profile to identify:
first contextual keywords present in the primary personalized profile that are absent from the updated personalized profile; and
second contextual keywords present in the updated personalized profile that are absent from the primary personalized profile;
removing the first contextual keywords from the personalized profile; and
adding the second contextual keywords to the personalized profile.

12. The method of claim 10, wherein modifying the primary personalized profile of the user based on the updated personalized profile of the user comprises:
comparing the contextual keywords of the primary personalized profile to the updated contextual keywords of the updated personalized profile to identify:
first contextual keywords present in the primary personalized profile that are absent from the updated personalized profile;
second contextual keywords present in the updated personalized profile that are absent from the primary personalized profile; and
third contextual keywords present in both the primary personalized profile and the updated personalized profile;
weighting the third contextual keywords with highest weights within the primary personalized profile;
adding the second contextual keywords to the primary personalized database and weighting the second contextual keywords with next-highest weights within the primary personalized database; and
weighting the first contextual keywords with lowest within the primary personalized profile.

13. A system comprising:
a processor; and
a storage device storing:
a personalized profile of a user; and
computer-executable code,
wherein the processor is to execute the computer-executable code to:
generate the personalized profile from at least a contextual information source regarding the user other than prior search queries made by the user; and
perform a search of an information store using a search query modified based on the personalized profile.

14. The system of claim 13, wherein the processor is to execute the computer-executable code to generate the personalized profile by determining contextual keywords from the contextual information of the user as the personalized profile.

15. The system of claim 14, wherein the processor is to execute the computer-executable code to perform the search by adding the contextual keywords to the search query.
